(19) United States
(12) Patent Application Publication
(10) Pub. No.: US 2012/0197970 A1
(43) Pub. Date: Aug. 2, 2012

(54) METHOD AND SYSTEM FOR MULTI-MEDIA OBJECT CREATION AND SOCIAL PUBLISHING OF SAME

(76) Inventor: Marie Clarke Arturi, Mattituck, NY (US)

(21) Appl. No.: 13/015,992

(22) Filed: Jan. 28, 2011

(51) Int. Cl. G06F 15/16

(52) U.S. Cl. 709/203

(57) ABSTRACT

A method and system for creating and socially publishing a multi-media object comprising selecting, with a user computing device, an object format from a plurality of object formats available from a database at a server computer; selecting, with the user computing device, at least one content component from a plurality of content components available from the database at the server computer for integration into the multi-media object; creating, with the user computing device in association with the server computer, the multi-media object in accordance with the selected object format and the selected content components; designating, with the user computing device, at least one recipient of the multi-media object, and distributing, by the server computer via a social publishing network, the multi-media object to the at least one designated recipient.

### TECHNICAL FIELD

This invention relates to a method and system for providing users with the ability to create multi-media objects online and have the objects disseminated to recipients with social publishing tools.

### BACKGROUND OF THE INVENTION

Social network services such as FACEBOOK in use today enables user to communicate with each other in various ways, share photos, chat, etc. It is desired, however, to provide for the implementation of a set of multi-media object creation tools to enable users to create multi-media objects and share the objects with selected recipients over the Internet.

### SUMMARY OF THE INVENTION

The present invention is a method for creating and socially publishing a multi-media object by selecting, with a user computing device, an object format from a plurality of object formats available from a database at a server computer; selecting, with the user computing device, at least one content component from a plurality of content components available from the database at the server computer for integration into the multi-media object; creating, with the user computing device in association with the server computer, the multi-media object in accordance with the selected object format and the selected content components; designating, with the user computing device, at least one recipient of the multi-media object; and distributing, by the server computer via a social publishing network, the multi-media object to the at least one designated recipient. The available object formats include a fixed dimension object format and a variable dimension object format. The available content components include background files, image files, text files, video files, audio files, drawing files, and embeddable web addresses. The recipients are designated from a listing of available recipients.

Additionally, a recipient viewing the multi-media object with a recipient computing device may select a content component from the multi-media object, and the selected content component then initiates a predefined action. If the selected content component is an audio file, then the predefined action initiated by the audio file is playback of audio content contained within the audio file. If the selected content component is a video file, then the predefined action initiated by the video file is playback of video content contained within the video file. If the selected content component is an image file, then the predefined action initiated by the image file is expansion of the image file to display at full resolution. If the selected content component is an embeddable web address, then the predefined action initiated by the embeddable web address is linking to content located at the web address.

Additionally, a recipient viewing the multi-media object with a recipient computing device may select a content component filter, and a subset of the content components is selectively displayed based on the selected filter.

The system of the present invention includes a user computing device interoperating with a server computer over a network. The user computing device is programmed to select an object format from a plurality of object formats available from a database at the server computer; select at least one content component from a plurality of content components available from the database at the server computer for integration into the multi-media object; create the multi-media object in accordance with the selected object format and the selected content components; store the multi-media object in the database at the server; and designate at least one recipient of the multi-media object. The server computer is programmed to distribute via a social publishing network the multi-media object to the at least one designated recipient.

In further accordance with the invention, a multi-media object creation and social publishing server computer is provided, which is programmed to provide to a user computing device, via a network, computer instructions that enable an operator of the user computing device to select an object format from a plurality of object formats available from a database at the server computer; select at least one content component from a plurality of content components available from the database at the server computer for integration into the multi-media object; send to the server computer multi-media object creation instructions in order to create the multi-media object in accordance with the selected object format and the selected content components; and designate at least one recipient of the multi-media object. The server computer is further programmed to receive the from the user computing device the multi-media object creation instructions; receive from the user computing device an identification of at least one designated recipient of the multi-media object; and distribute via a social publishing network the multi-media object to the at least one designated recipient.

### BRIEF DESCRIPTION OF THE DRAWING

FIG. 1 illustrates a top level illustration of the various interactions of the preferred embodiment of the present invention.

FIG. 1a is a flowchart of the object creation and publishing processes of the present invention.

FIG. 2 illustrates a screen shot of a web page for starting the creation of the multi-media object, in which the object style may be selected.

FIG. 2a illustrates a screen shot of a web page for selecting the format of the multi-media object.

FIG. 3 illustrates a screen shot of a web page for initiating the editing of the look and feel of the multi-media object.

FIG. 4 illustrates the selection of a predefined theme for the multi-media object.

FIG. 5 illustrates the selection of a customized background for the multi-media object.

FIG. 6 illustrates a screen shot of a web page for adding and editing various multi-media content for the multi-media object.

FIG. 7 illustrates a screen shot of a web page for entering a text field into the multi-media object.

FIG. 8 illustrates a screen shot of a web page that shows the text field entered onto the multi-media object.

FIG. 9 illustrates a screen shot of a web page in which an image has been added to the multi-media object.

FIG. 10 illustrates a screen shot of a web page in which a free-form drawing is created on the fly for the multi-media object.

FIG. 11 illustrates a screen shot of a web page in which the free-form drawing has been added to the multi-media object.

FIG. 12 illustrates a screen shot of a web page in which tags are assigned to the multi-media object.

FIG. 13 illustrates a screen shot of a web page in which the user can initiate sharing of the multi-media object.

FIG. 14 illustrates a screen shot of a web page in which the fixed multi-media object is displayed on a web page.

FIG. 14a illustrates a screen shot of a web page in which an image of the multi-media object is selected and displayed at full resolution on a web page.

FIG. 14b illustrates a screen shot of a web page in which a filter is selected to display only the text content of the multi-media object.

FIG. 15 illustrates a screen shot of a web page for creation of free or expandable two-dimensional multi-media object.

FIG. 16 illustrates a screen shot of a web page in which the free or expandable two-dimensional multi-media object is displayed on a web page.

FIG. 16a illustrates a screen shot of a web page in which the free or expandable two-dimensional multi-media object is displayed on a web page and shifted partially to the right.

FIG. 16b illustrates a screen shot of a web page in which the free or expandable two-dimensional multi-media object is displayed on a web page and shifted partially to the left.

FIG. 16c illustrates a screen shot of a web page in which the free or expandable two-dimensional multi-media object is displayed on a web page and shifted partially down.

FIG. 16d illustrates a screen shot of a web page in which the free or expandable two-dimensional multi-media object is displayed on a web page and shifted partially down and to the left.

FIG. 17 illustrates a screen shot of a web page for creation of a flow or expandable one-dimensional multi-media object.

FIG. 18 illustrates a screen shot of a web page in which the flow or expandable one-dimensional multi-media object is displayed on a web page.

FIG. 18a illustrates a screen shot of a web page in which the flow or expandable one-dimensional multi-media object is displayed on a web page in an expanded format.

FIG. 18b illustrates a screen shot of a web page in which the flow or expandable one-dimensional multi-media object is displayed on a web page in an expanded format and shifted partially to the left.

### DETAILED DESCRIPTION OF THE PREFERRED EMBODIMENTS

The present invention is for a method and system for creation of a multi-media object and distributing the object to recipients. The system enables users to create content via a client device such as a user computing device executing a web browser that interacts with a content creation and social publishing distribution server, and then implement a social publishing methodology to distribute the content as desired.

### Multi-Media Object Creation

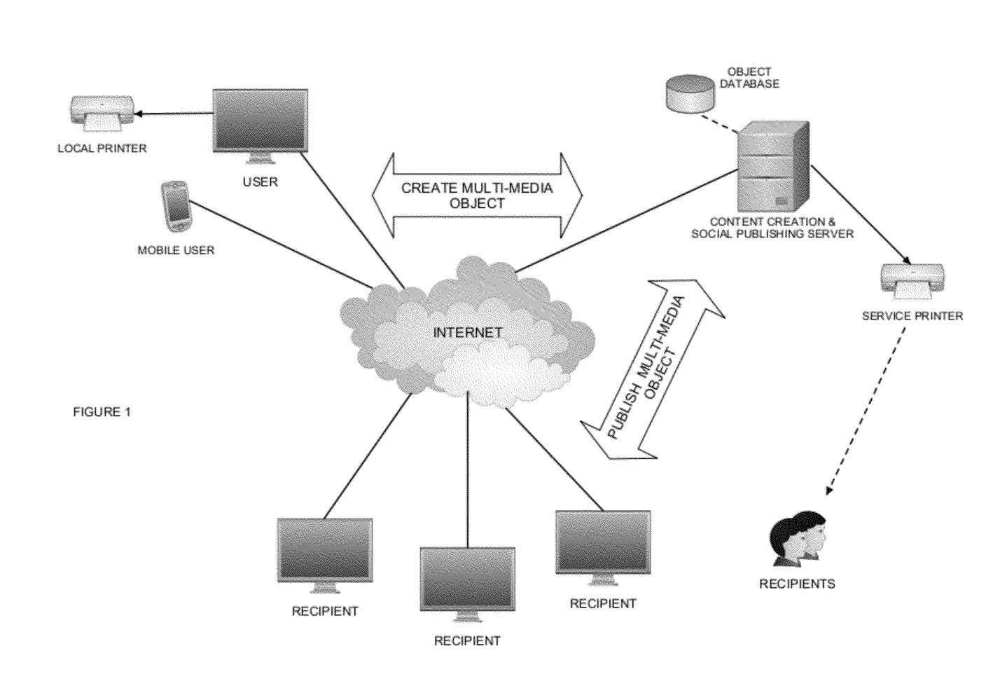

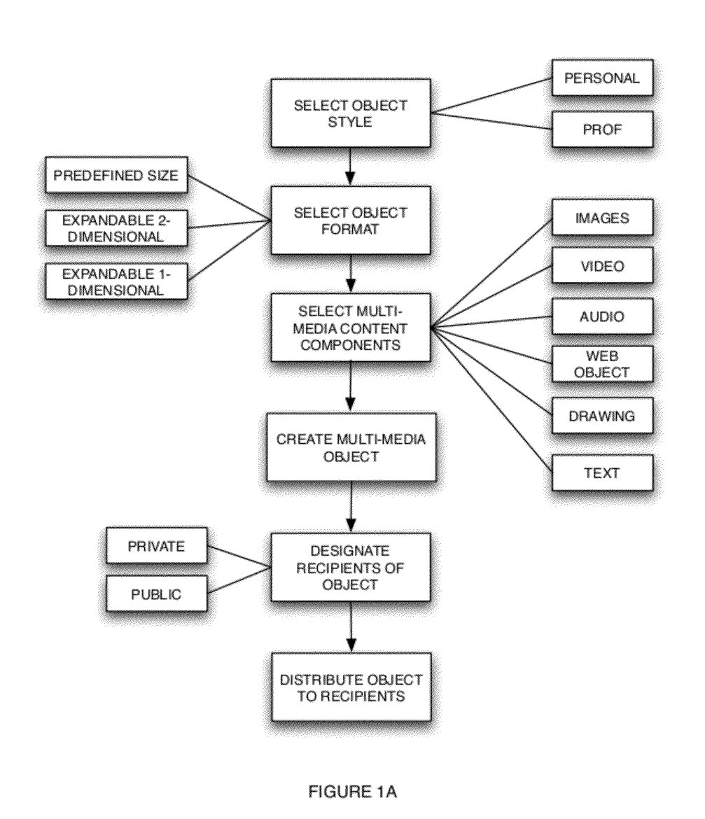

FIG. 1 illustrates a top level illustration of the various interactions of the preferred embodiment of the present invention, and FIG. 1a is a flowchart of the object creation and social publishing processes of the present invention. A user is interconnected with a user computing device to the Internet in order to communicate via a web browser interface with the content creation and social publishing server, also referred to herein as the BUNCEE multi-media object creation and social publishing server. As used herein, the term “BUNCEE” is a trademark of the Applicant for its multi-media object that will have a background, theme, images, text, movies, music, freeform drawings, web links, etc. The user may operate on any type of client computing platform such as but not limited to a desktop computer, a laptop computer, or a mobile device such as a mobile phone or tablet device. In the preferred embodiment, the multi-media object creation and publishing server implements a web server interface so that any user computing device using a web browser may interact with the server under this invention. In the alternative, a stand-alone application may be implemented at the user client computing device, which may operate on a given operating system such as WINDOWS, MAC OS, LINUX, CHROME, etc. Additionally, a dedicated mobile application may be provided that is suitable for use with mobile devices that operate for example the IOS operating system (e.g. IPHONES and IPADS), the ANDRIOD operating system, BLACKBERRY OS, WEB OS, etc., although these mobile devices may also interact with the server via a mobile web browser or remote database connection as well known in the art. Thus, virtually any client-server system is envisioned to be able to operate with the present invention, wherein the user operates the client device to interact with the content creation server as will now be explained.

The user will therefore interact with the multi-media object server and its associated object database in order to create multi-media objects and control social publishing of the objects to recipient computing devices as described further herein. Recipient computing devices also are client devices in the same manner as the user computing devices; i.e. a desktop computer, a laptop computer, or a mobile device such as a mobile phone or tablet device. Optionally, multi-media objects may be printed locally by the users or recipients, or they may be printed by a printer service operating in conjunction with the multi-media object server for automatic distribution via postal mail and the like. It is noted that the network shown is the public Internet, but other wide area networks and/or local area networks may also be used for the interaction between the users, the multi-media object server, and the recipients as desired. For example, an enterprise may implement an enterprise embodiment in which a private multi-media object system operates over a LAN or WAN in which object creation and publishing is more tightly controlled and not publicly available.

Thus, in a preferred embodiment, a user operating a desktop or laptop computer will be able to use a web browser interface in order to interact with the content creation platform that is hosted by the multi-media object creation server computer. For example, a user operating a typical desktop computer will open a browser and enter the URL of the multi-media object creation server computer (e.g. http://www.buncee.com) into the address window, or in the alternative a URL link may be used to click for access to the server, etc. Once the user reaches the home page of the content creation and social publishing web site, he may log in with a user name and password. If the user is visiting the site for the first time he may create an account by entering a user name, password, and other required information as well known in the art.

Once the user has logged in, he is presented with a web page that has several options, including a Create option that allows the user to create a multi-media object. As shown in FIG. 1a, the process operates generally by a user first selecting an object style, which may be a personal style or a professional style. Next, the user selects the object format, which may be a fixed dimension object format or a variable dimension object format. The fixed dimension object format is a predefined size format (also referred to as a fixed format). The variable dimension object format is in the preferred embodiment an expandable 2-dimensional format (also referred to as a free format), or an expandable 1-dimensional format (also referred to as a flow format), all of which are described further herein. Next, the user can create and modify the content and the look and feel of the object by selecting from various multi-media object components available from the server computer or created on the user computing device. The multi-media object is then created at the server computer as a result of the selection and placement of these components. The user may then designate one or more recipients of the multi-media object (e.g. public or private), and the object is distributed to the designated recipients. All of these steps will now be explained in further detail.

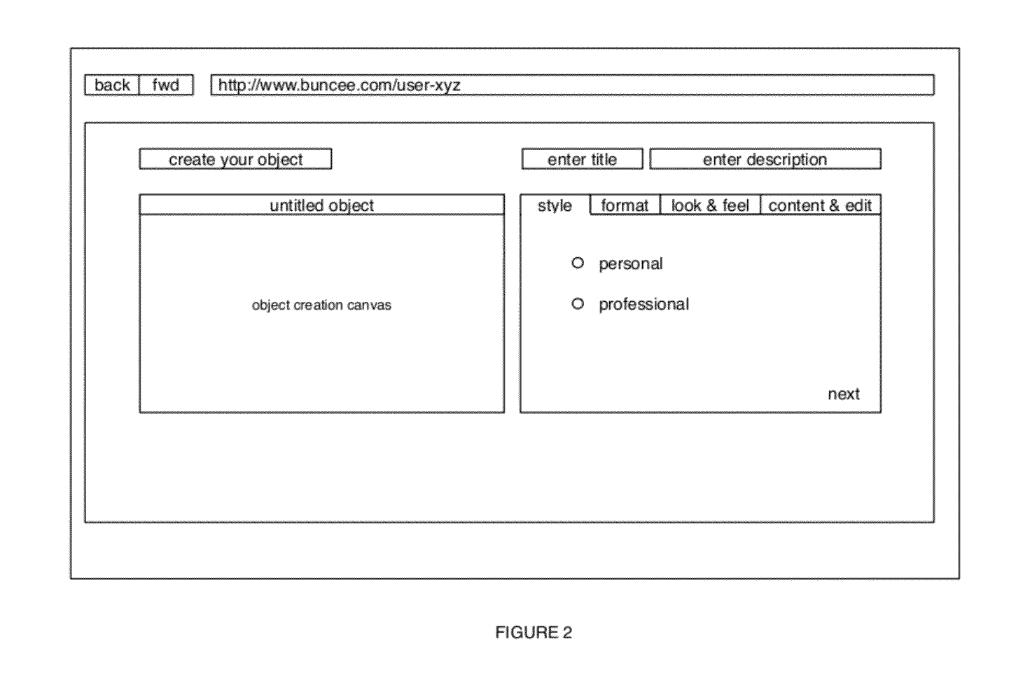

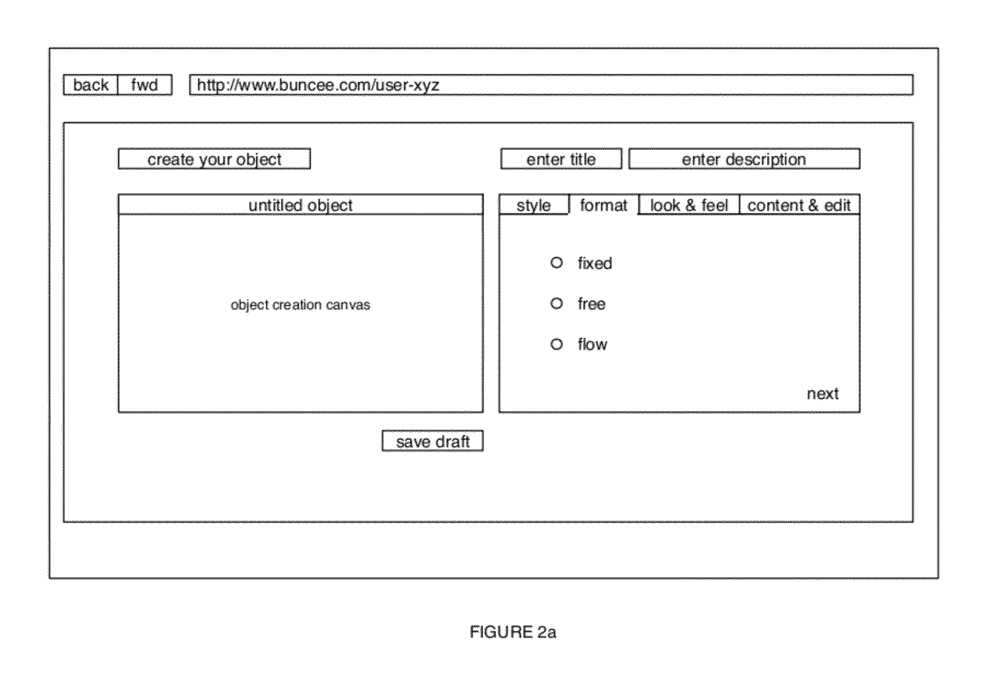

FIG. 2 illustrates a screen shot of the Create Your Object web page selected by the user in order to create and/or edit a multi-media object. First, the user is given the option to create a personal style multi-media object or a professional style multi-media object. The creation process is essentially the same regardless of which style is selected, although the specific content made available to the user may vary. That is, the professional style will make available content that is of a more professional nature, while the personal style will make available content that may be of a more personal nature. Next, the user can select the Format tab (or select the Next button) and will be presented with the web page of FIG. 2a, which illustrates a screen shot of a web page for selecting the format of the multi-media object.

At this web page of FIG. 2a the user can select an object format from a plurality of available object formats. In the preferred embodiment, the user may create a fixed dimension object or a variable dimension object. Of course, different object formats may be made available by the system programmer if desired. The fixed dimension object format (also referred to as a fixed format object) has a predefined area with predefined borders where the user may add content as described herein. The fixed dimension object enables the user to create greeting cards, for example, which may be mailed out to users as described further herein.

The variable dimension object format provides for expansion in one or both of the X and Y axes (rather than being a fixed size as in the fixed format object). In one case, the free format object is that which is expandable in both the X and Y axes (i.e. in 2-dimensions). That is, the free format object is a multi-directional object that does not have predefined borders, in which the user may add as many content items as desired, and which may be placed anywhere in the object. Viewers of the free format object are able to scroll or pan it vertically and/or horizontally in a virtually unlimited manner. This will be more fully described herein.

In the other case of the variable dimension object format, the flow format object is that which is expandable in only one of the X or Y axes, (i.e. 1-dimensional). That is, the flow format object has only one set of predefined borders, and is able to scroll and expand in the X or Y direction, and is bound in the other direction with predefined borders. In the preferred embodiment, the flow format object is fixed in the vertical (Y) direction and is virtually unlimited in the horizontal (X) direction. This lends itself to viewing the inserted content in a linear fashion, such as in a timeline manner. This will also be more fully described herein.

### Fixed Format Object

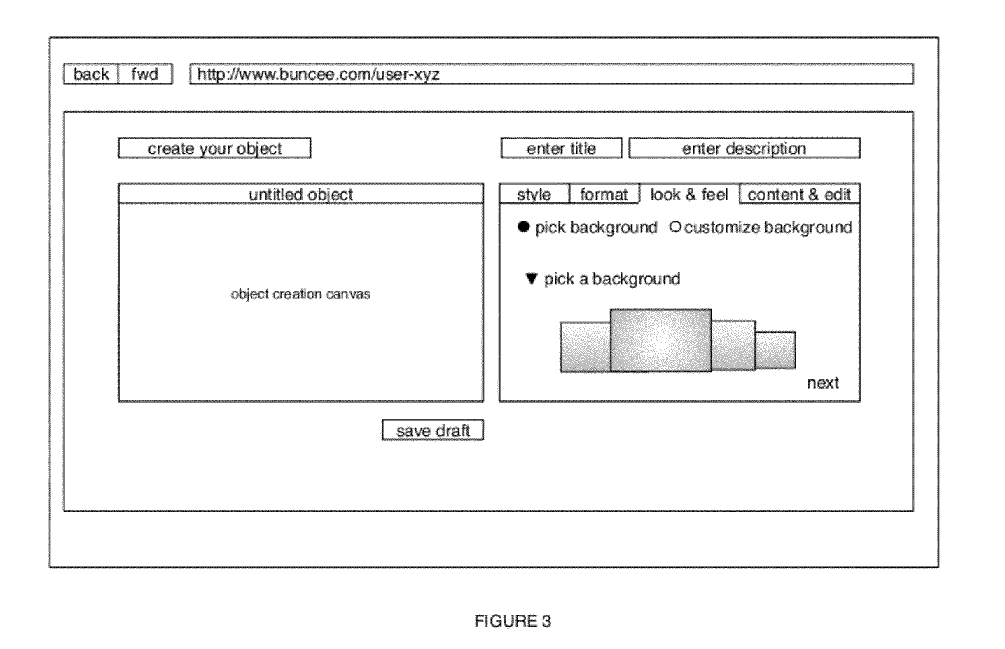

Assuming that the fixed format object is selected, the user will then select at least one content component from a plurality of available content components for integration into the multi-media object. That is, the user can edit the look and feel of the object as follows. FIG. 3 illustrates a screen shot of a web page for initiating the editing of the look and feel of the multi-media object. For example, when the user selects the fixed format object, he is taken to the web page as shown in the screen shot of FIG. 3 (he can also navigate there by selecting the Look and Feel tab).

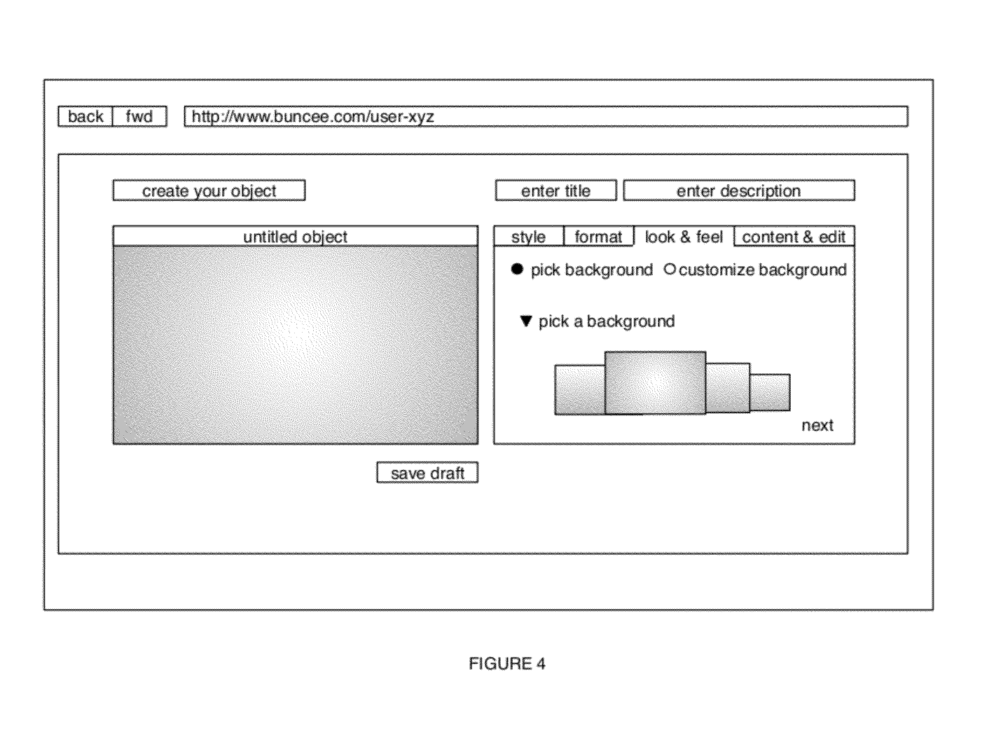

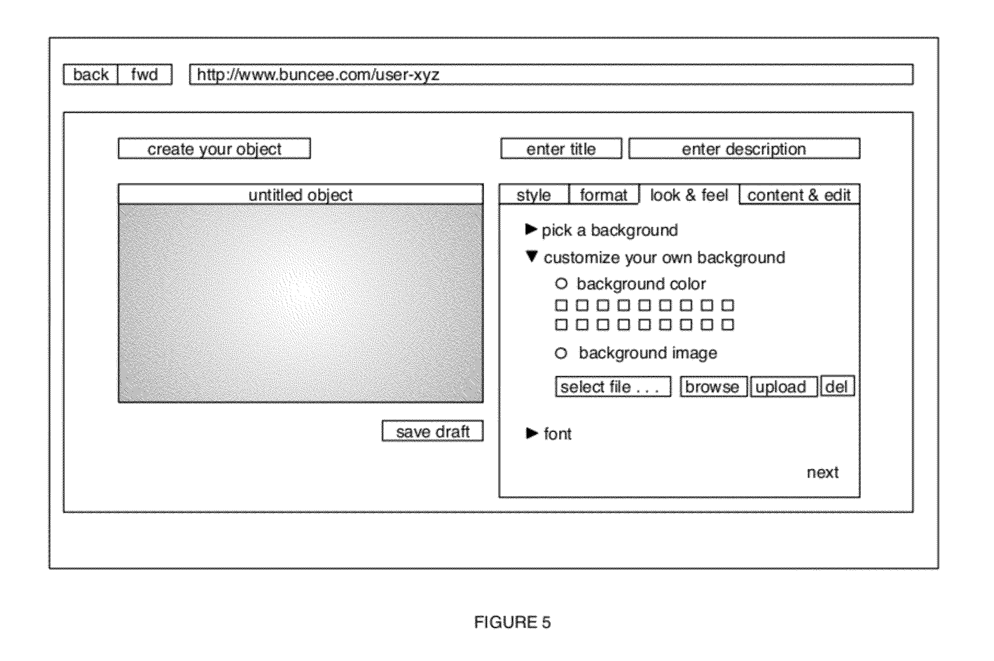

The user may first pick a background from a set of provided backgrounds, such as a wood grain background, a filmstrip background, graph paper background, etc. These backgrounds are provided in a scrollable thumbnail presentation to the user as shown in FIG. 3. FIG. 4 illustrates the selection of a predefined background for the object, in particular a radial blend background. In the alternative, the user may select a customize background option as shown in FIG. 5, in which a background color may be selected form a palette, and/or a background image may be selected by browsing images from the user's computing device, then selecting the desired image and uploading it to the server computer. The user then may select his desired font style, size and color for text entries from the font drop down menu of FIG. 5. This would complete the Look and Feel section for the multi-media object creation. The selections made by the user for the object format as well as the background and fonts is uploaded to the server computer for storage at the database and use with the creation of this multi-media object.

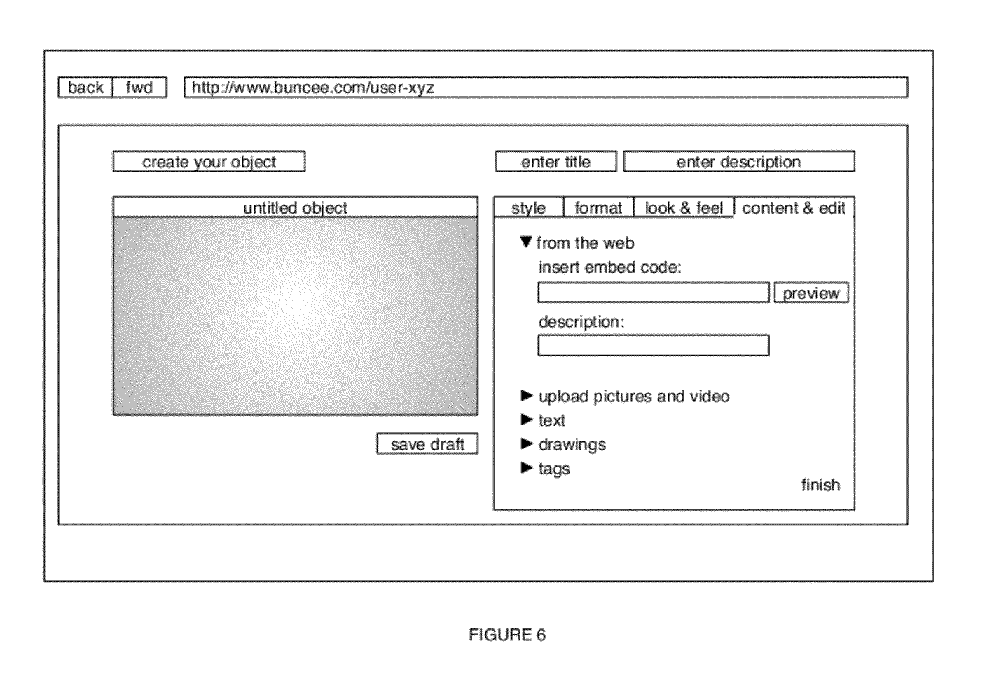

Once the user has selected his background and font for the object, he clicks the Next button and is taken to a web page as shown in FIG. 6, which illustrates a screen shot of a web page for adding and editing further multi-media content for the object (he can also navigate there by selecting the Content and Edit tab). The available multi-media content components include but are not limited to image files, text files, video files, audio files, drawing files, clip art files, and embeddable web content, as will be explained in further detail herein.

As shown in FIG. 6, the user may embed code such as a web address in order to insert a web object such as video from YOUTUBE or VIMEO, images from PICASA or FLICKR, feeds from TWITTER, WIKIPEDIA articles, and web pages and blog content, etc. By inserting appropriate code in this section, the web content linked by that code is made available to the viewer of the multi-media object as known in the art. The entries made by the user for any embeddable web content is uploaded to the server computer for storage at the database and use with the creation of this multi-media object.

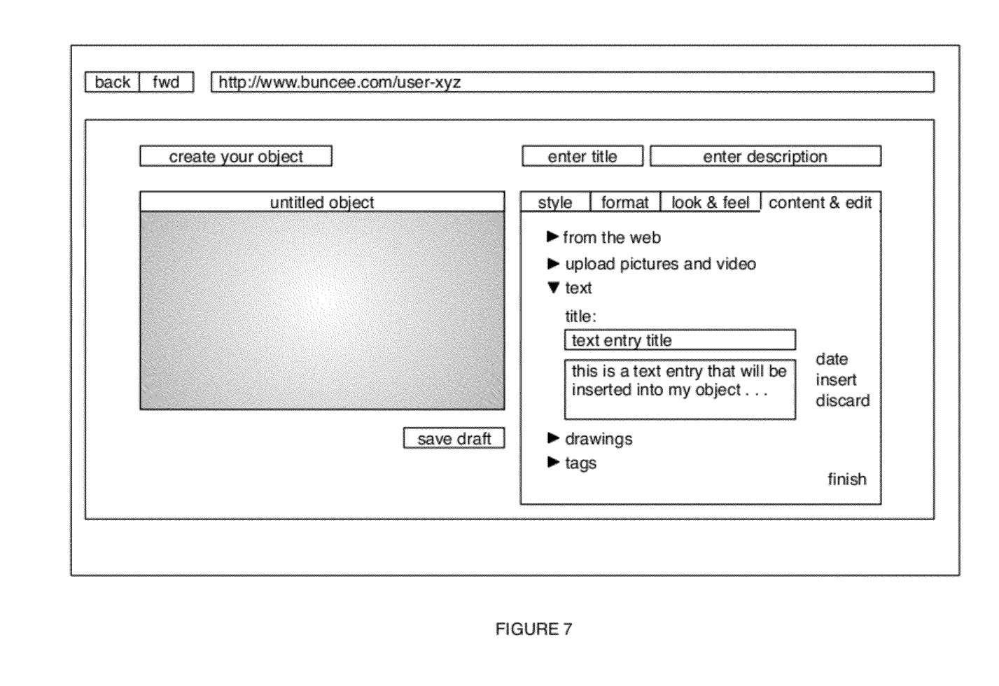

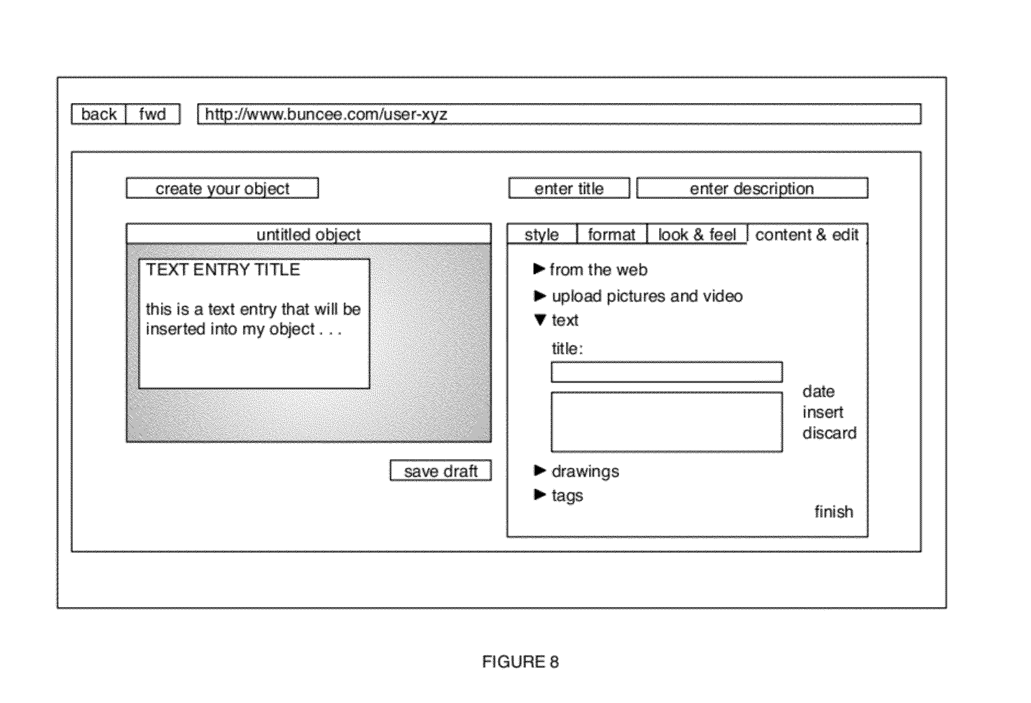

A text file may also be created by the user on the web page and uploaded as shown in FIG. 7. There, the user will enter a title for the entry, the text of the entry, and optionally a date may be set for the entry. The date field is especially useful for the flow format object that is expandable in the X-direction, which may be configured as a timeline. Once the text field is inserted by selecting Insert, it will appear on the background as shown in FIG. 8. This may be moved around the object as desired by the user by manipulating an appropriate input device (such as a mouse, trackpad, touchscreen, etc.) It may also be edited or deleted if desired. Additionally text fields may be added in the same manner. The text entries made by the user are uploaded to the server computer for storage at the database and use with the creation of this multi-media object.

At any time, the user may select the Save Draft button and the object in its present state will be saved to the server computer. This would include storage at the server computer of instructions that reference the selected content components, their relative position in the object, etc. The draft object may be opened at a later time for editing and publishing as desired.

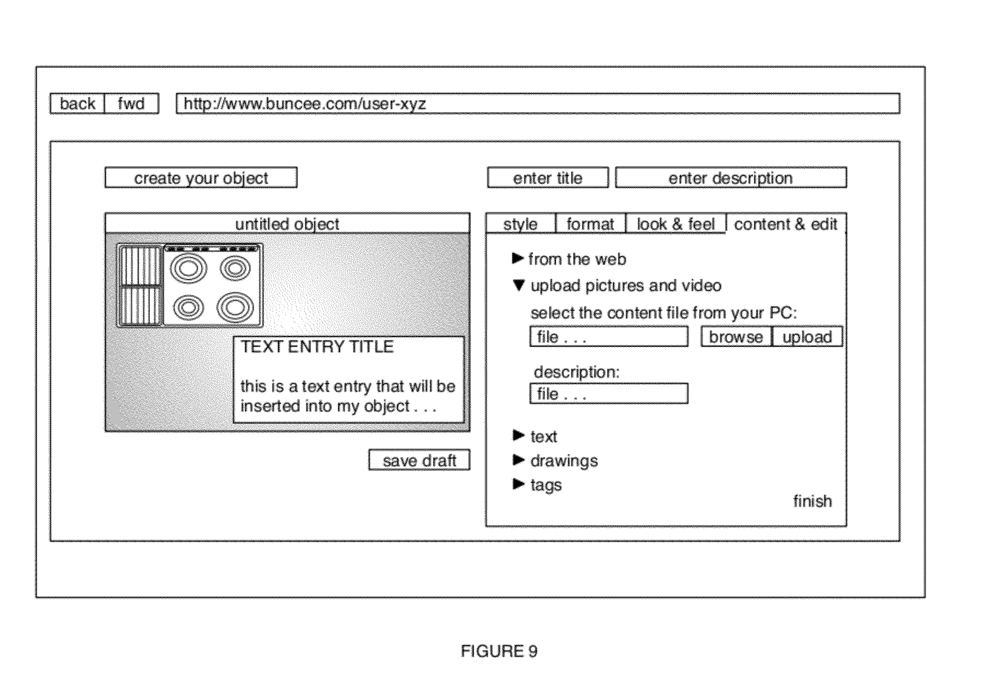

The user may also select and upload multimedia files such as image files, video files, and/or audio files from his own computing device, which may be placed in the object as shown in FIG. 9. By selecting this option, the user is provided with window that will enable him to navigate his computing device to find and upload the desired images and/or audio or video files. In FIG. 9, the user has selected an abstract image file from his computing device, which has been placed on the object background above and next to the text entry as shown. The user may also create audio and/or video content in real time, such as by using a built-in camera and/or microphone of the user computing device to record a video or audio message. The multimedia files selected by the user are uploaded to the server computer for storage at the database and use with the creation of this multi-media object.

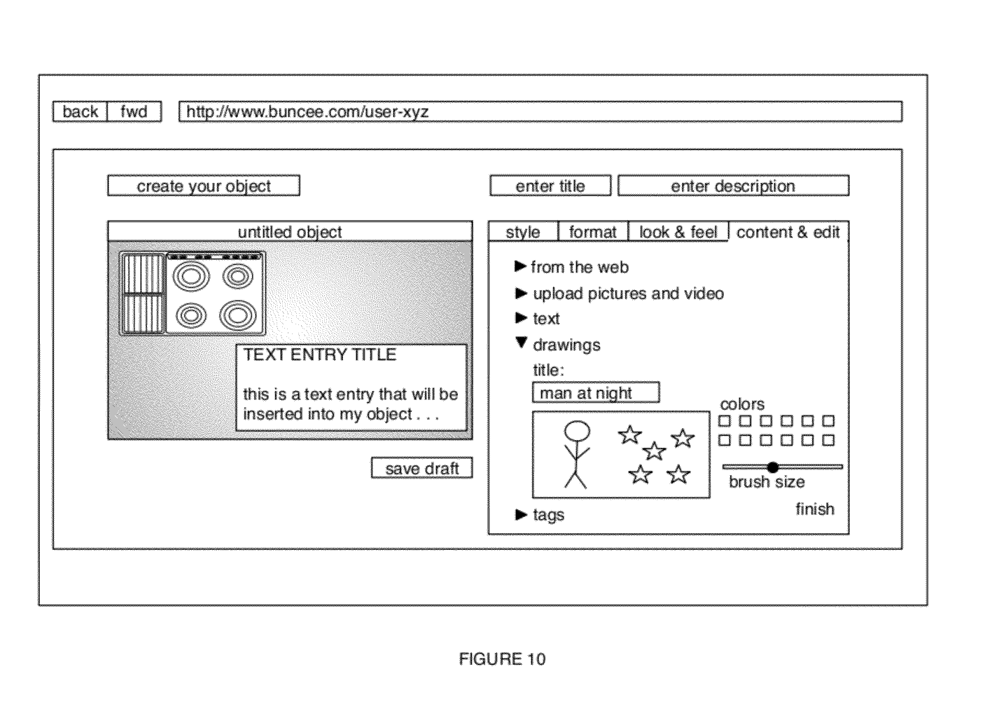

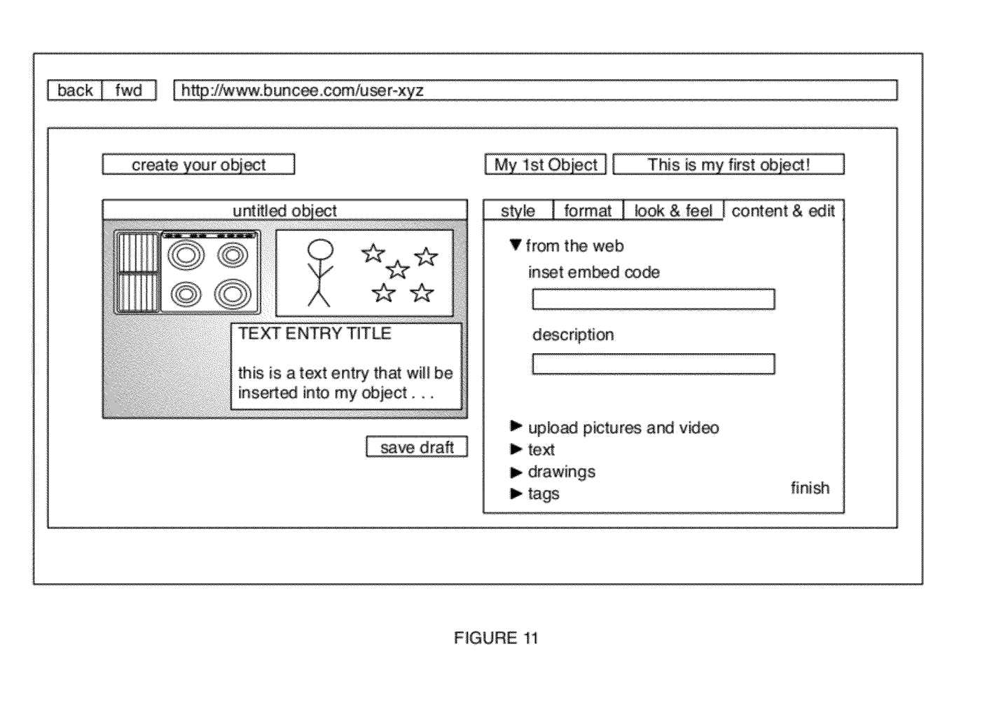

FIG. 10 illustrates a screen shot of a web page in which a free-form drawing is created using a drawing tool interface. In particular, the drawing option is provided to the user, by which he may make a free form drawing in the canvas provided by selecting a brush color and size, which may also be inserted into the object. An input device (e.g. mouse, trackpad, touchscreen) is then used to create the drawing as known in the art. In FIG. 10, the user has created a drawing and named it Man at Night. FIG. 11 illustrates a screen shot of a web page in which the free-form drawing has been added to the object. The drawing files created by the user are uploaded to the server computer for storage at the database and use with the creation of this multi-media object.

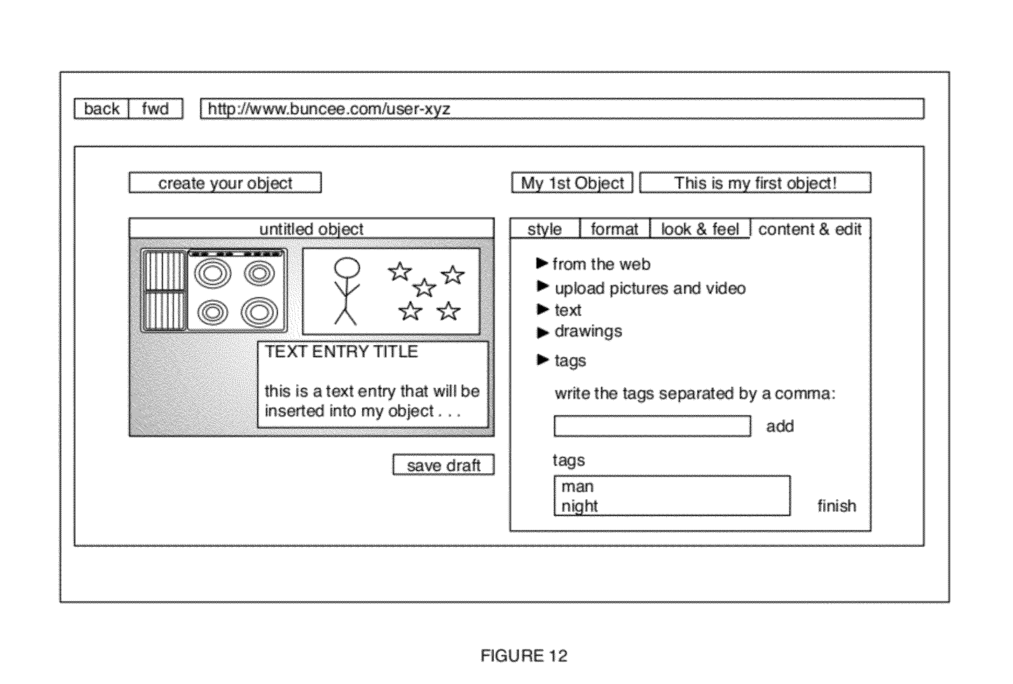

FIG. 12 illustrates a screen shot of a web page in which tags are assigned to the multi-media object. The Tags option allows the user to create and/or select existing descriptive words and phrases to append to the object for organizational and searching purposes as known in the art. In FIG. 12, the tags “man” and “night” have been created by the user. The tags designated by the user are uploaded to the server computer for storage at the database and use with the creation of this multi-media object.

As the user creates the multi-media object by inserting content, a preview of that content is generated and manipulated by the user so it is located on the object as desired. When the object is eventually viewed on the web, the content items contained are seen and may be selected and then expanded to normal resolution. The previews that are located in the object during creation may be re-sized as desired by selecting the preview and grabbing handles that appear on the screen.

After the user has added and edited the desired content to the multi-media object as described above, he may then save a draft of the object for later editing, or he may finish the object by selecting the desired button from the web page. If he has not already entered a title he will be prompted to do so, and he may enter a description as well. Once the user selects the Finish button, he is given the option of Go To Drafts, Continue Editing, or Publish and Share. If he selects Go To Drafts, the multi-media object will be saved at the server computer database for future editing and he will be presented with a web page that shows all of his draft objects stored in the server computer database, any of which may be selected for further editing or publication. If he selects Continue Editing he may continue the edit process, and if he selects Publish and Share then he will enter the next phase of the process.

### Publish and Share

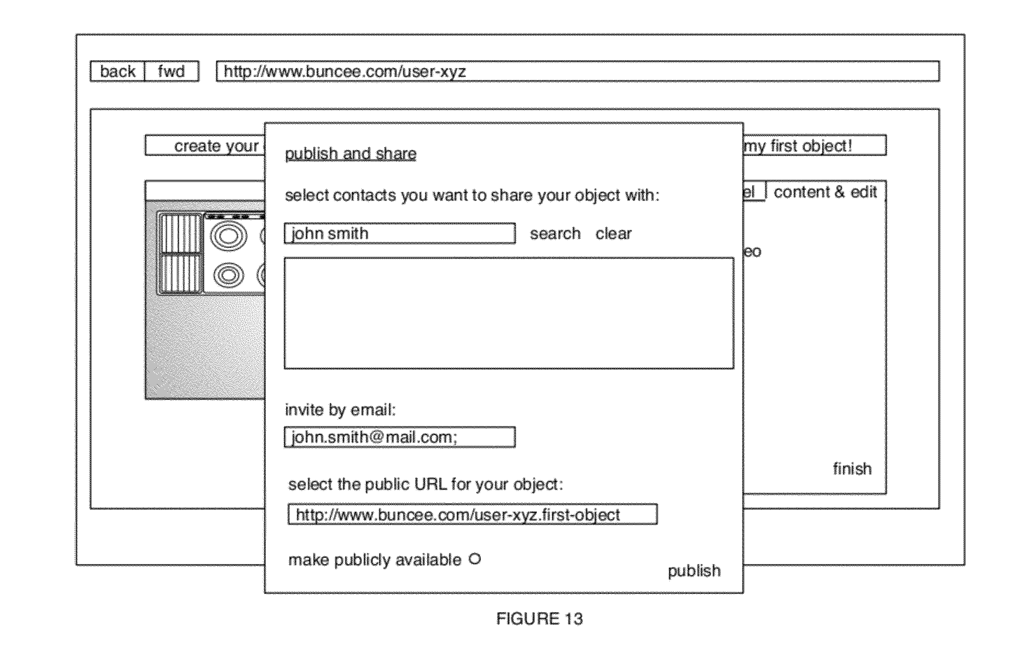

When the user selects the Publish and Share option, he will be presented with the pop-up window of FIG. 13, which illustrates a screen shot of a web page in which the user can initiate sharing of the multi-media object. There, he can enter one or more identifying indicia of those with whom he wishes to share the object on a private basis (such as email address, screen name, etc.). He may also have a list of email addresses already uploaded on the server (e.g. his BUNCEE “friends”), from which he can easily select the desired recipients. Those email addresses may be obtained from the user's local address book stored on the user's computing device, or the server may be able to link to one or more of various commercial email provider databases, such as YAHOO, GMAIL, and HOTMAIL, in order to obtain the user's address book from those sources.

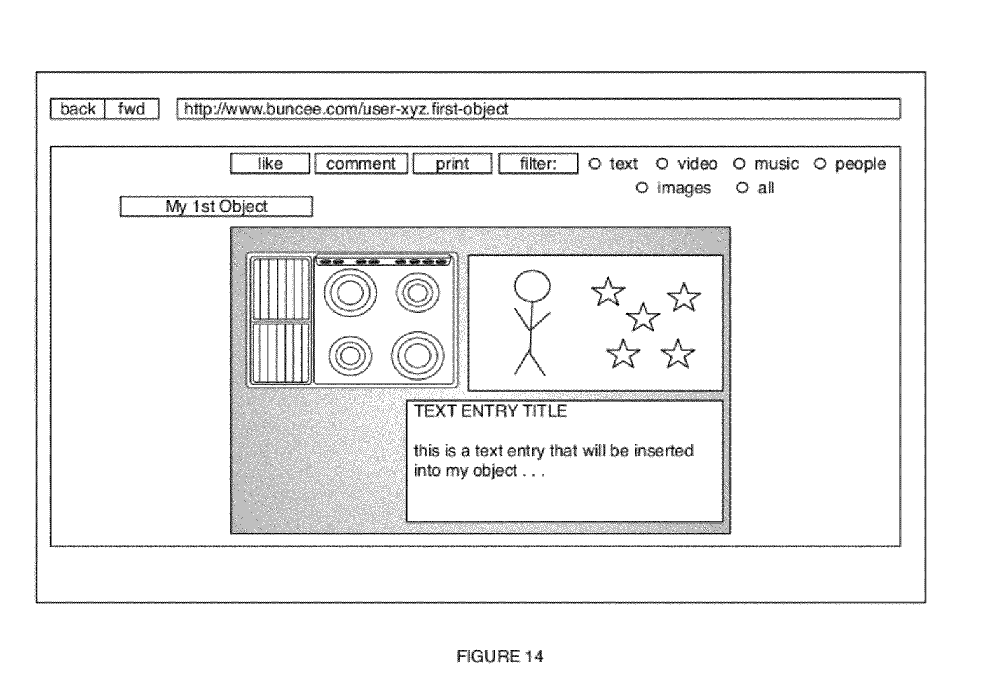

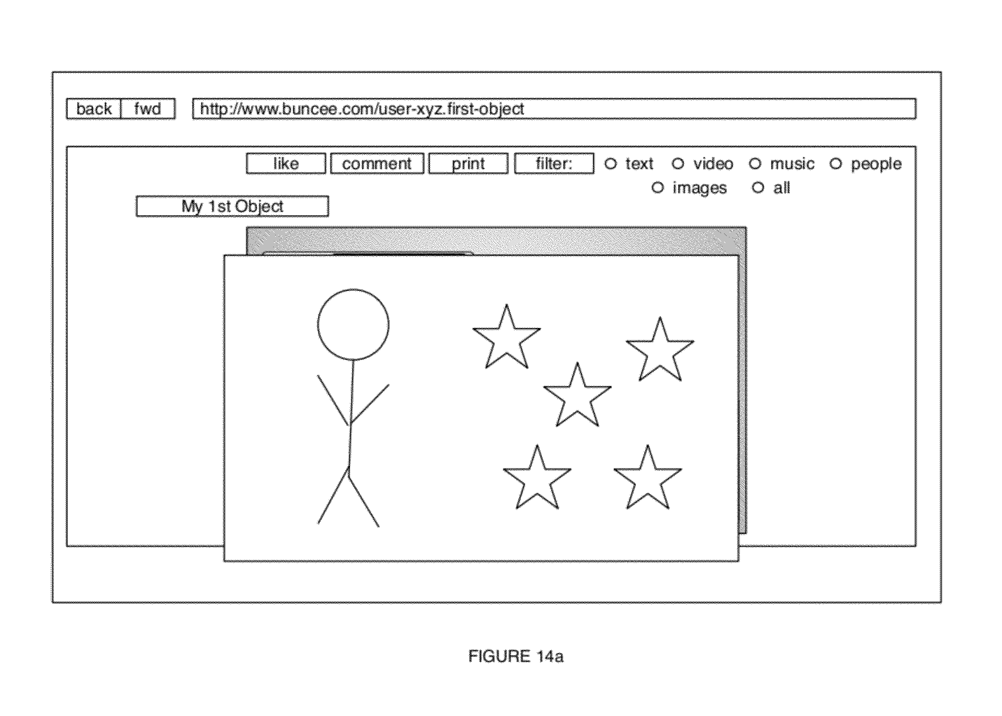

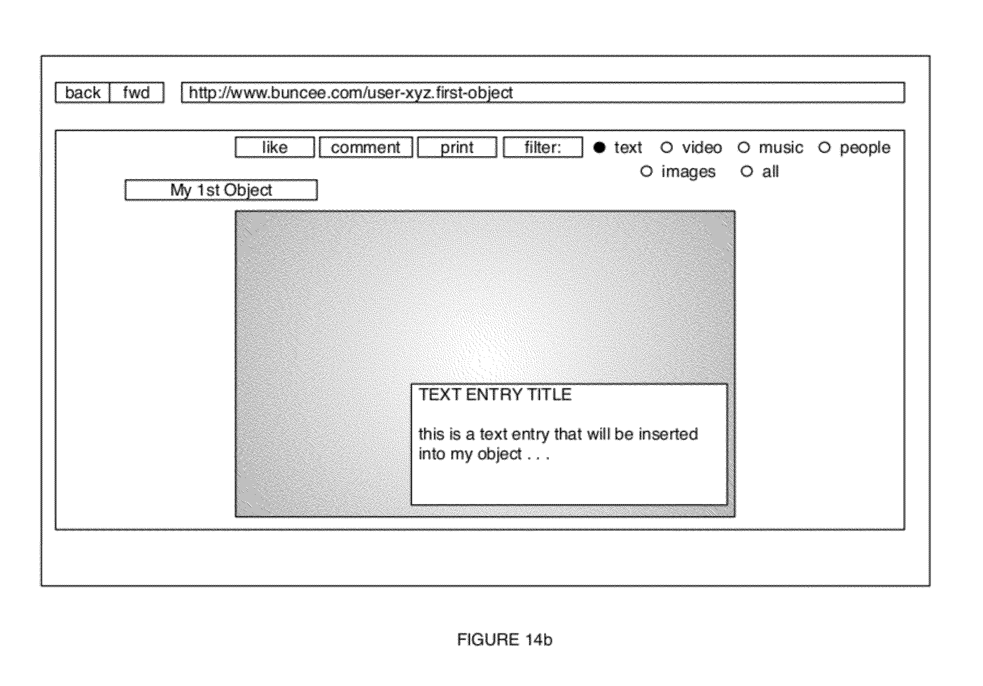

After the user selects the recipient(s), the server will generate and send notifications (e.g. email(s)) to each recipient(s) which will invite that recipient to view the object on the server with a recipient computing device by providing a thumbnail preview of the object, a link to a URL that hosts the object, and an identification of the user who sent him the invitation to view the object. By selecting the URL link, the recipient will be taken to a web page that will display the object for viewing as shown in FIG. 14. The object may be viewed as a whole, and/or each element of the object that was inserted by the user during the creation process may be selected individually. An image file will be expanded to full resolution when selected, and any date or title that was associated with that image will be displayed. FIG. 14a illustrates a screen shot of a web page in which a drawing component of the multi-media object is selected and displayed at full resolution on a web page. Likewise, if a web element such as a YOUTUBE video was embedded, then selecting that element will allow the recipient to view the video as linked from the web source (such as the YOUTUBE site). Optionally, a set of display filters is provided that allows a recipient to view only certain types of content as desired. For example, in FIG. 14b, the recipient has selected the text filter, which causes only the text portions to be displayed. The other filters—Video, Music, People, Images or All—may be used to display whichever content types are desired by the recipient at that time. Of course, this does not change the object itself, only which types of content are displayed to the recipient as selected.

Anyone who views the object may enter and/or view comments that will be displayed along with object, or he may select a Like (or Dislike) button as shown in FIG. 14. The object may also be printed by the recipient by selecting a print button, which will generate a high resolution file.

An alternative to private invitations and viewing of the object is to make the object visible to everyone (see FIG. 13). When this Make Publicly Available option is selected, a public URL is provided by the server at which that object will be hosted. The user may then circulate that URL to anyone as desired, i.e. by email, TWITTER, on a web site, etc.

### Social Network Integration

The present invention may be integrated with existing social networks such as FACEBOOK. For example, the FACEBOOK connect APIs integrate with this invention in order to allow a user to use his or her FACEBOOK contacts in order to send multi-media objects to selected recipients, without having to re-enter all of the contact information for those people. The multi-media objects may also be shared to existing social networks such as by posting a thumbnail preview of the multi-media object to the user's FACEBOOK wall, with a link to the actual object.

### Variable Dimensional Objects—X and Y Axes

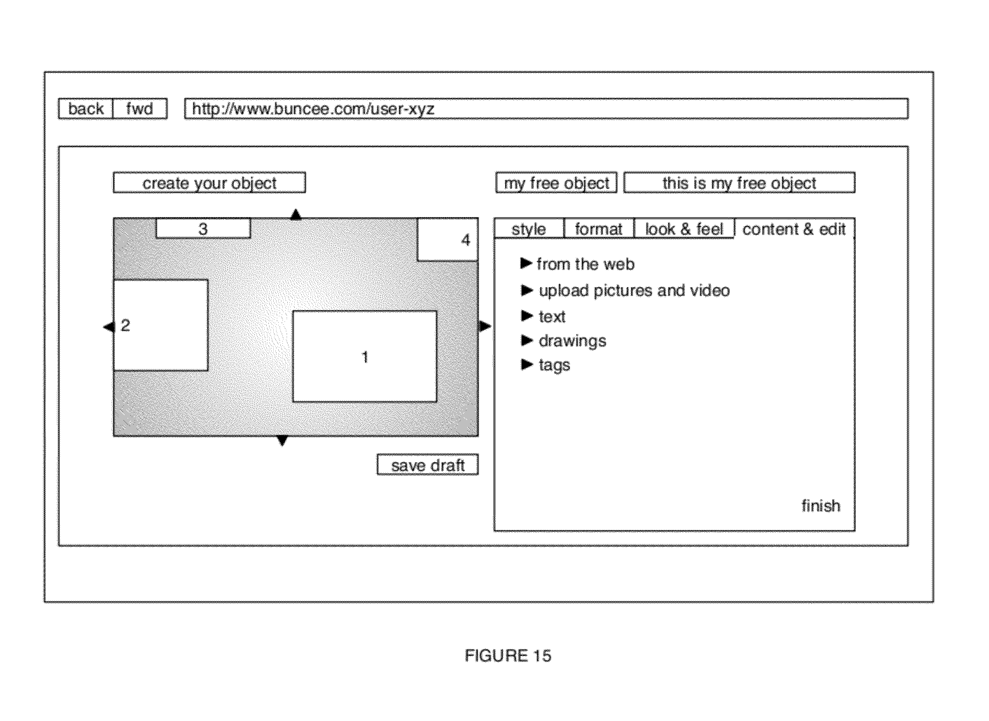

The free format object, which is variable in both the X and Y axes (2-dimensional), will now be described. All of the content creation and editing tools described above with respect to the fixed format object are also available to the user when creating a free format object. However, in this embodiment, the canvas on which the content is placed extends virtually without limits in both the vertical and horizontal directions. FIG. 15 shows a screen shot of a free format object (expandable 2-dimensional) with navigational arrows at each side of the canvas that has been populated with several content components (1,2,3 and 4), which the user can select with an input device and cause the object canvas to slide in that direction. This enables placement of content anywhere in the virtual canvas. As can be seen, object component 1 is fully displayed, content component 2 is partially hidden from view on the left side, content component 3 is partially hidden from view of the top, and content component 4 is partially hidden from view at the top and on the right side. By selecting any of the four arrows on the edges of the canvas, those content components may be viewed and manipulated (re-sized and re-located) as desired.

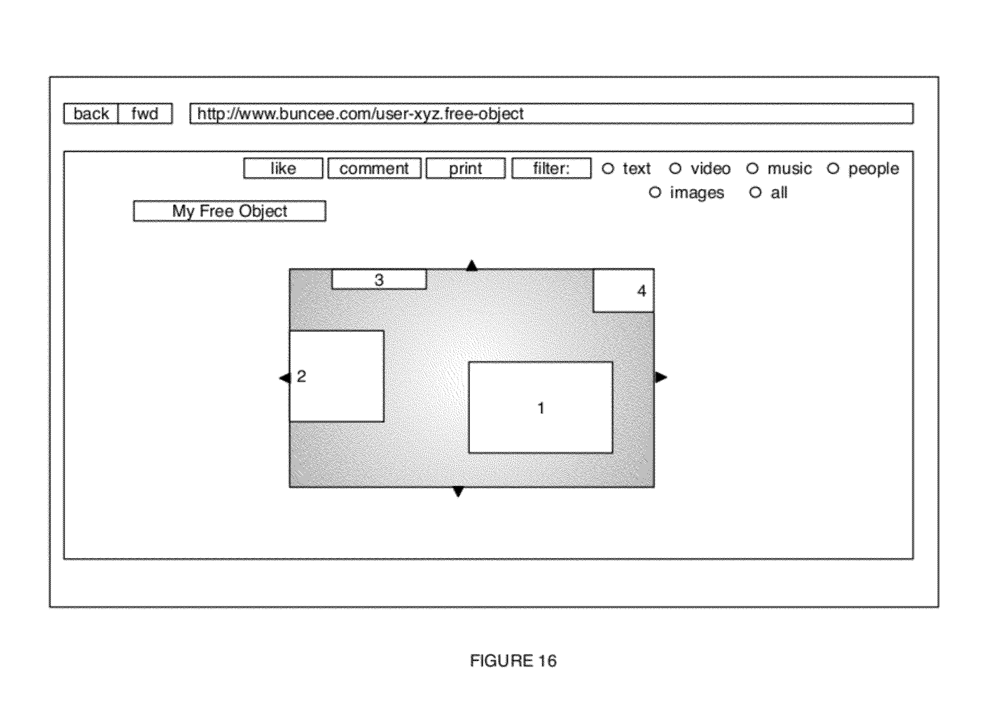

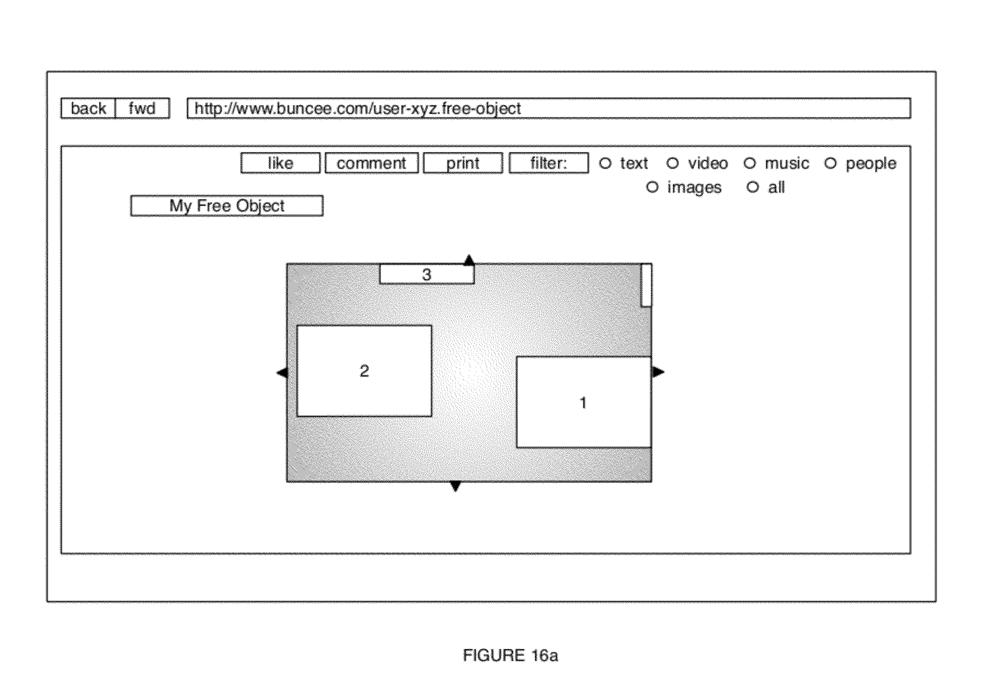

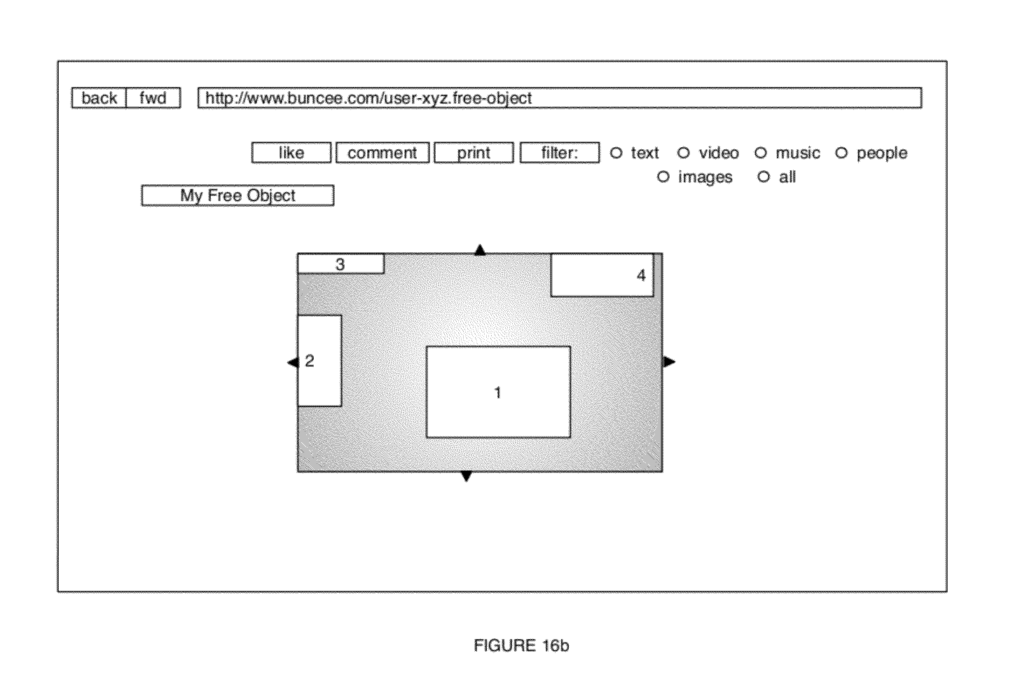

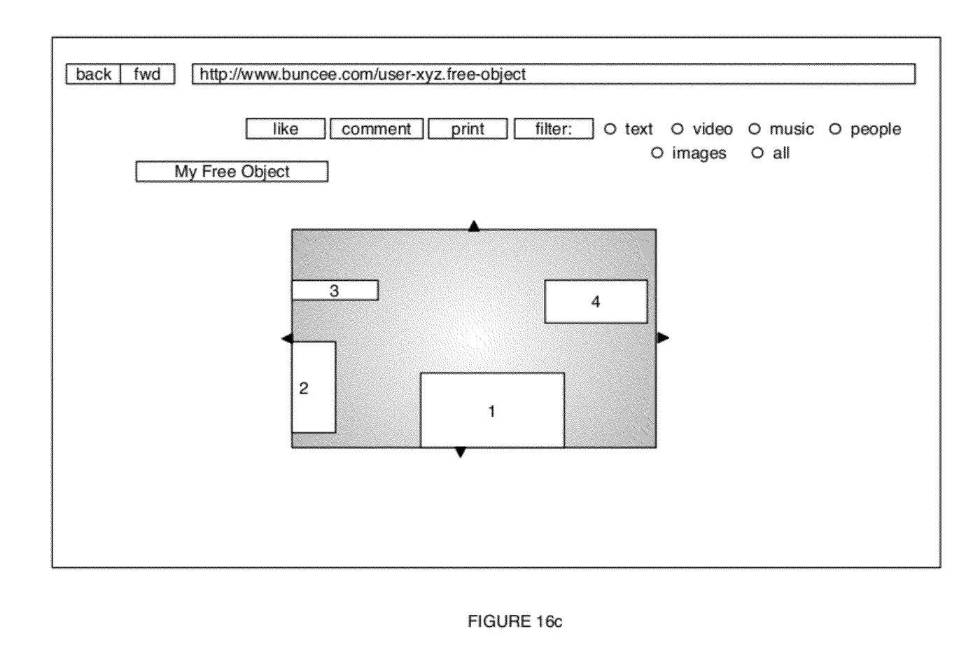

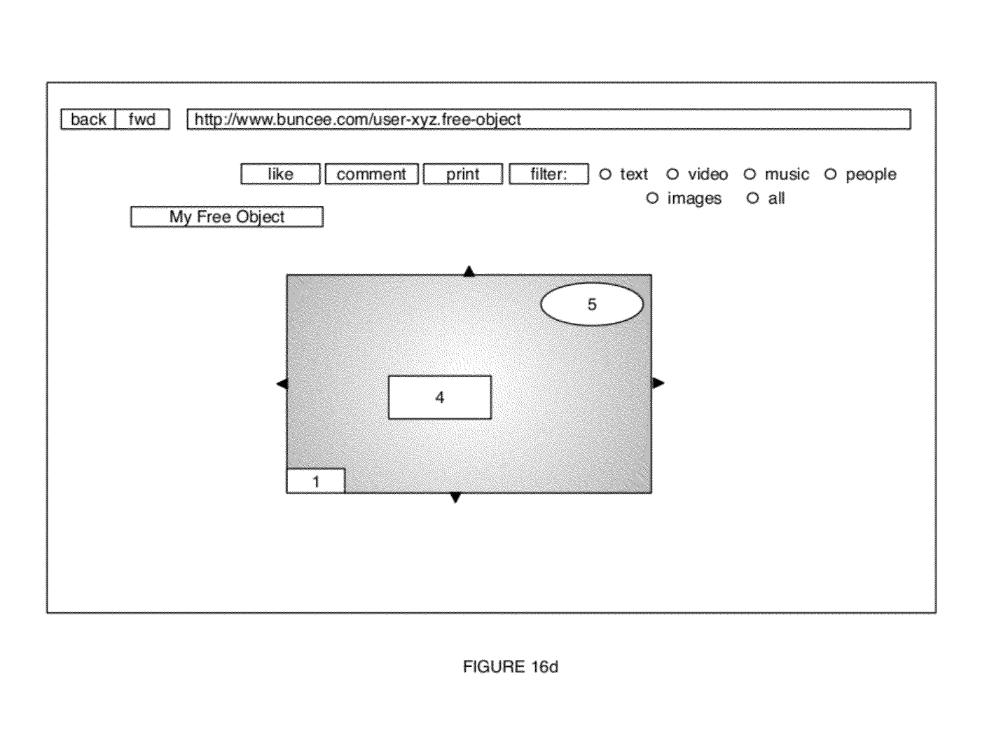

FIG. 16 illustrates a screen shot of a web page in which the free or expandable 2-dimensional multi-media object is displayed on a web page. Much more of the published object may be viewed at one time, depending of course on the resolution and size of the display monitor being used and the web browser. The published object has the same four navigational arrows that enable the viewer to navigate the entire two-dimensional space of the object as desired. FIG. 16a illustrates a screen shot of a web page in which the free or expandable two-dimensional multi-media object is displayed on a web page and shifted partially to the right. This enables the entirety of content component 2 to be viewed. FIG. 16b illustrates a screen shot of a web page in which the free or expandable two-dimensional multi-media object is displayed on a web page and shifted partially to the left. This enables more of content component 4 to be viewed. FIG. 16c illustrates a screen shot of a web page in which the free or expandable two-dimensional multi-media object is displayed on a web page and shifted partially down. This enables the entirety of content component 2 to be viewed. FIG. 16d illustrates a screen shot of a web page in which the free or expandable two-dimensional multi-media object is displayed on a web page and shifted partially down and to the left. This enables the entirety of content component 5 to be viewed, which was previously not viewable.

### Variable Dimensional Objects—X or Y Axes

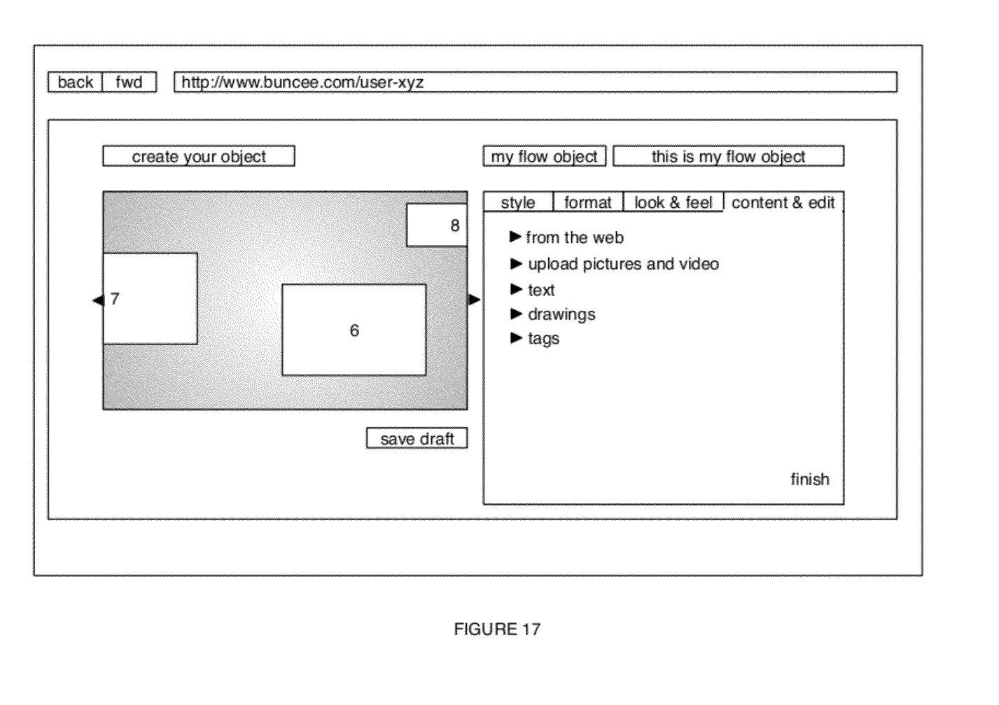

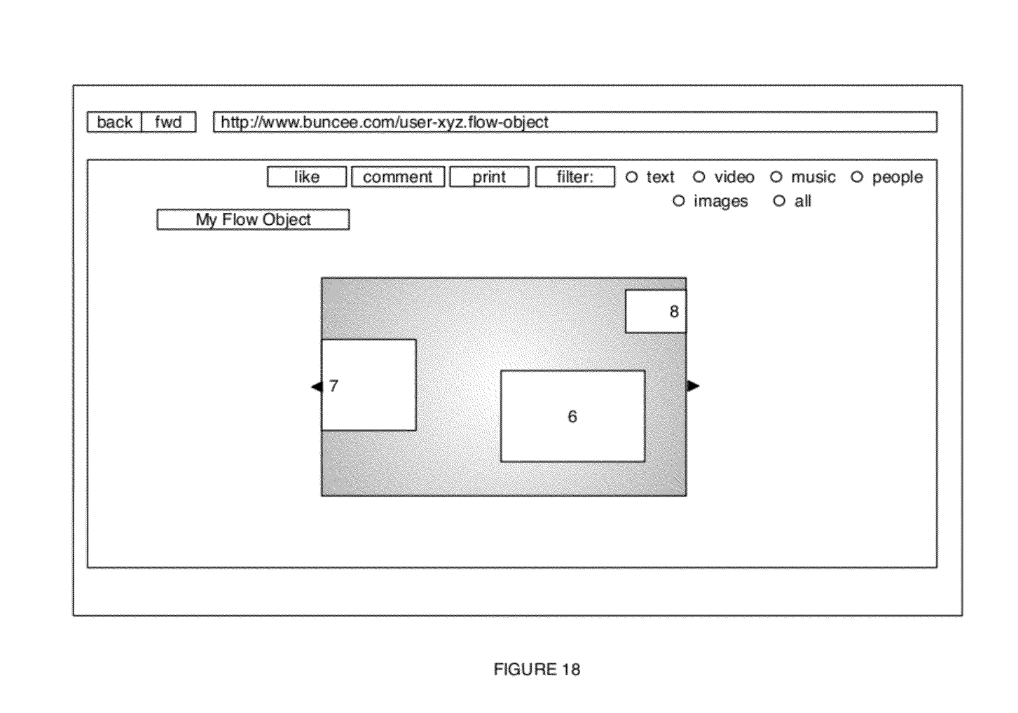

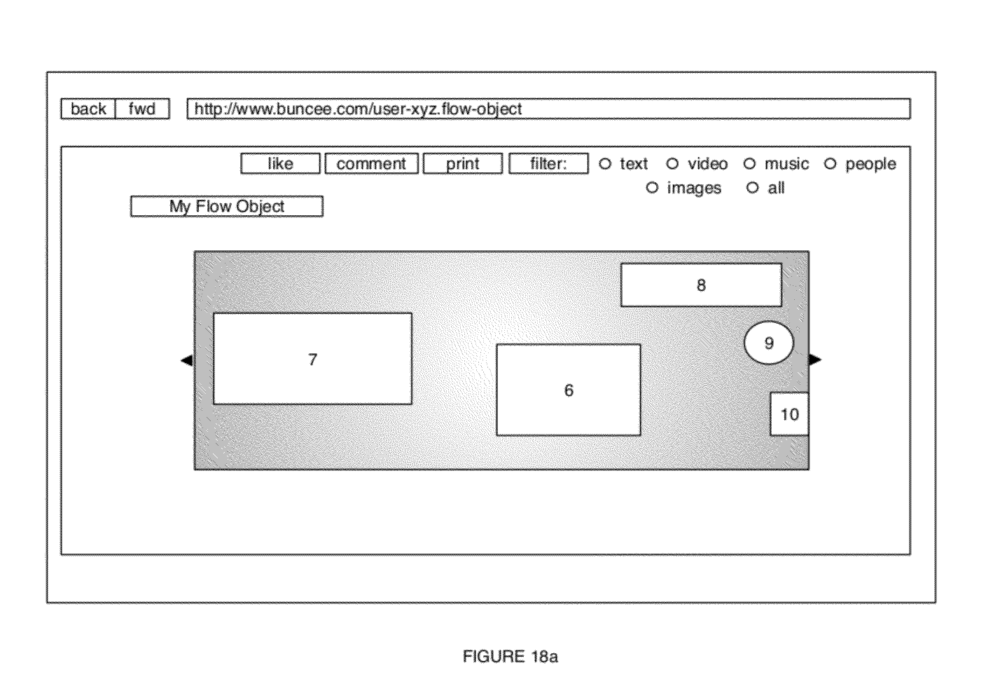

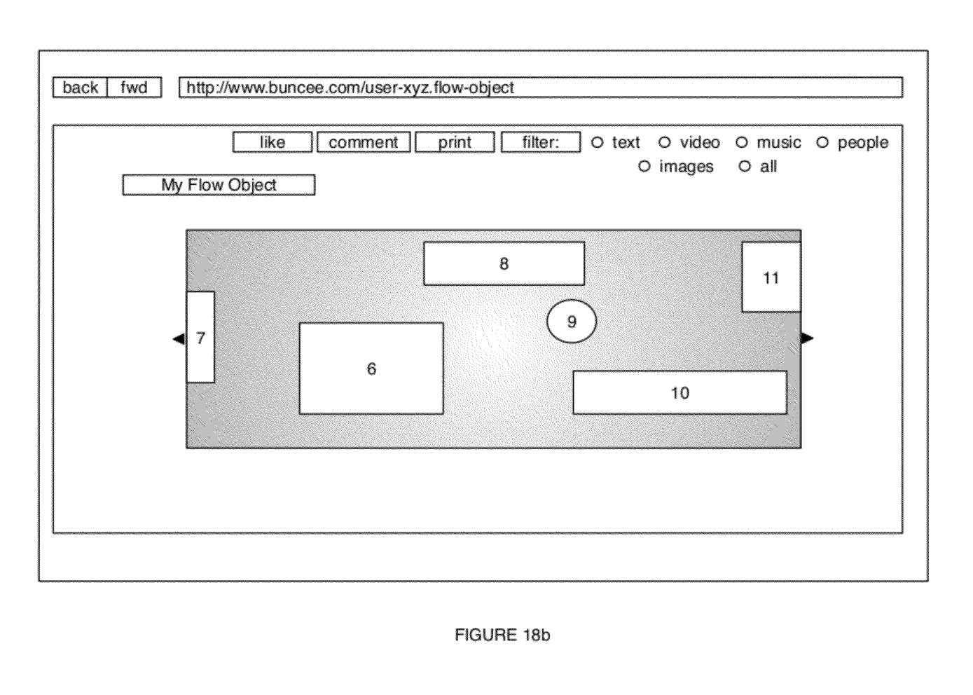

The flow format object, which is variable in either the X or Y axes (1-dimensional), will now be described. The canvas on which the content is placed extends virtually without limits in only the horizontal directions. This lends itself to timeline applications, in which content is added to the right as time progresses. FIG. 17 shows a screen shot of an expandable one-dimensional object canvas with navigational arrows at the left and right sides only that has been populated with several content components (6, 7 and 8), which the user can select with an input device and cause the object canvas to slide in that direction. This enables placement of content components anywhere along the horizontal axis in the virtual canvas. As can be seen, the content component 8 on the far right side is partially obscured. By selecting either of the two arrows, those content components may be viewed and manipulated (re-sized and re-located) as desired. FIG. 18 shows the flow format object that has been published on the web. Much more of the published object may be viewed at one time, depending of course on the resolution and size of the display monitor being used and the web browser. The published flow format object has the same two navigational arrows that enable the viewer to navigate the entire horizontal space of the expandable one-dimensional object as desired.

FIG. 18a illustrates a screen shot of a web page in which the flow or expandable one-dimensional multi-media object is displayed on a web page in an expanded format.

As can be seen, content component 7 is fully displayed, as is content component 8. In addition, previously hidden content components 9 and 10 as now viewable. FIG. 18b illustrates a screen shot of a web page in which the flow or expandable one-dimensional multi-media object is displayed on a web page in an expanded format and shifted partially to the left. This enables the entirety of content component 10 to be viewed, and previously hidden content component 11 is now shown.

### Applications

Numerous applications may be implemented with the present invention. For example, a company catalog may be generated with the present invention and distributed by mass emailing, a link from a company website, a TWITTER feed, etc. Likewise, users can use a multi-media object in order to distribute family pictures, for example of a newborn baby, that can be added to as the baby gets older. The timeline feature of the expandable one-dimensional object or flow format object would be especially suitable for this application.

In addition to being published on the web, objects may be printed in hard copy as well as PDFs. The predefined size objects are made available in certain sizes so that they may be easily printed and distributed, such as holiday cards. To make a BUNCEE card, a user would enter a text message(s) such as “Happy Valentine's Day!”, and then insert desired images such as a heart or cupid arrow. In one embodiment, holiday themed graphics and backgrounds would be provided to enable the user to more readily accomplish this.

The multi-media object may be played back in an automated manner. Foe example, if the multi-media object contains several video files, an automatic playback of the object might cause the video files to play in succession without requiring user intervention. Likewise, if image files are present, they may be automatically selected and enlarged to full resolution in a predefined order in a slideshow presentation style, with or with accompanying music from an audio file in the object. This may be accomplished for example by an optional record feature at the time of object creation, where the user selects a record button from the interface and then plays back the desired object files. The order of file selection will be recorded and integrated into the multi-media object, so when a recipient views the object that prerecorded playback scenario will be repeatable without user intervention.

Likewise, the user may select an option at the time of creation (or at viewing) that can generate a video file from the playback/viewing of the object, for example in MP4 format. The end result would be an MPF or other type of video file that can be distributed as desired. Likewise, a presentation file such as a POWER POINT presentation file may be created for use in a presentation mode.

### Implementation

Now that the functionality of the present invention has been described, the implementation is provided. As mentioned above, the user computing device may be any device suitable for operating as a client device, such as a desktop or laptop computer, a mobile device such as a smart phone or tablet, etc. The user computing device operates a web browser on the preferred embodiment, but may also operate a dedicated program that can interoperate with the server over the network. Likewise, the recipient or viewer of the multi-media object may operate any recipient computing device such as a desktop or laptop computer, a mobile device such as a smart phone or tablet, etc., acting also in a client capacity to view the multi-media object from the server.

The multi-media object is created and stored at the server as shown in FIG. 1, and in particular a database is used to store the content (as well as the content attributes such as the position within the multi-media object). As web pages are served from a web server program executing at the server, those web pages are received by the browser program executing at the user computing device, such that the user may manipulate the content creation process at the server database as described above. Known content creation tools are used as needed, such as browser plug-ins such as a drawing plug-in required for user-created drawings. Similarly, user-created video and/or audio files will be created using available hardware in association with the user computing device. As the user creates content, it is uploaded to the server database and stored in association with the user's account at the database. For example, text instructions are sent to the server during the creation process using POST protocols (e.g. “the X-coordinate is 357, the Y-coordinate is 512”). As a non-limiting example, a MySQL database may be used with the present invention. The multi-media object may be created for example with layered HTML as know in the art, and it may be sent back to the server as JSON (JavaScript Object Notation).

The multi-media object is stored at the server database as text and references to images and other content components. The text, which contains the attributes of the media components, and the references to the media components, are stored in the MySQL database. When the object is to be viewed by a recipient, a link to the layered HTML multi-media object is sent in the web application embodiment herein described. The multi-media object is drawn on the display screen at the user computing device in accordance with the attributes stored at the database. Thus, for example, the background selected by the user is retrieved from the database, along with other stored components (predefined by the system or user-generated), which are positioned according to the information that was stored during the creation process. In the event that the recipient wishes to print the multi-media object (or share it on social networks), then the server will use the object creation information and create an image of the object such as a JPEG or PDF. Additionally, on mobile devices, however, such as an IPHONE or IPAD, which may execute dedicated client programs, a JPEG or PDF image of the multi-media object is transmitted to the mobile device for viewing.

In another example, when the multi-media object is shared in a social network such as on a FACEBOOK wall, a flattened image such as JPEG is created, with a link back to the server that enables a viewer to link to the fully functional object at the server and have that object recreated as described above (e.g. streaming media, embedded media, etc.). Similarly, when a multi-media object is created and then shared from a mobile device such as an IPAD, a flattened image of that object may be created an attached as an image to an email sent by the user for sharing. Flattened multi-media objects may be of course be stored locally on the user computing device such as an image stored in IPHOTO.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method for creating and socially publishing a multi-media object comprising the steps of:
a. selecting, with a user computing device, an object format from a plurality of object formats available from a database at a server computer,
b. selecting, with the user computing device, at least one content component from a plurality of content components available from the database at the server computer for integration into the multi-media object,
c. creating, with the user computing device in association with the server computer, the multi-media object in accordance with the selected object format and the selected content components,
d. designating, with the user computing device, at least one recipient of the multi-media object, and
e. distributing, by the server computer via a social publishing network, the multi-media object to the at least one designated recipient.

2. The method of claim 1 wherein the plurality of available object formats comprises a fixed dimension object format and a variable dimension object format.

3. The method of claim 1 wherein the plurality of available content components comprise a background file, an image file, a text file, a video file, an audio file, a drawing file, and an embeddable web address.

4. The method of claim 1 wherein a plurality of recipients are designated from a listing of available recipients.

5. The method of claim 1 further comprising the steps of:
f. a recipient viewing the multi-media object;
g. the recipient selecting a content component from the multi-media object;
h. the selected content component initiating a predefined action.

6. The method of claim 6 wherein the selected content component is an audio file, and wherein the predefined action initiated by the audio file is playback of audio content contained within the audio file.

7. The method of claim 6 wherein the selected content component is a video file, and wherein the predefined action initiated by the video file is playback of video content contained within the video file.

8. The method of claim 6 wherein the selected content component is an image file, and wherein the predefined action initiated by the image file is expansion of the image file to display at full resolution.

9. The method of claim 6 wherein the selected content component is an embeddable web address, and wherein the predefined action initiated by the embeddable web address is linking to content located at the web address.

10. A multi-media object creation and social publishing system comprising a user computing device interoperating with a server computer over a network, wherein
a. the user computing device is programmed to:
i. select an object format from a plurality of object formats available from a database at the server computer,
ii. select at least one content component from a plurality of content components available from the database at the server computer for integration into the multi-media object,
iii. create the multi-media object in accordance with the selected object format and the selected content components,
iv. store the multi-media object in the database at the server; and
v. designate at least one recipient of the multi-media object; and
b. the server computer is programmed to distribute via a social publishing network the multi-media object to the at least one designated recipient.

11. The system of claim 10 wherein the plurality of available object formats comprises a fixed dimension object and a variable dimension object.

12. The system of claim 10 wherein the plurality of available content components comprise a background file, an image file, a text file, a video file, an audio file, a drawing file, and an embeddable web address.

13. The system of claim 10 wherein a plurality of recipients are designated from a listing of available recipients.

14. The system of claim 10 further comprising:
c. a recipient computing device programmed to:
i. display the multi-media object received from the server computer;
ii. enable selection of a content component from the multi-media object; and
iii. the selected content component initiating a predefined action.

15. The system of claim 14 wherein the selected content component is an audio file, and wherein the predefined action initiated by the audio file is playback of audio content contained within the audio file.

16. The system of claim 14 wherein the selected content component is a video file, and wherein the predefined action initiated by the video file is playback of video content contained within the video file.

17. The system of claim 14 wherein the selected content component is an image file, and wherein the predefined action initiated by the image file is expansion of the image file to display at full resolution.

18. The system of claim 14 wherein the selected content component is an embeddable web address, and wherein the predefined action initiated by the embeddable web address is linking to content located at the web address.

19. A multi-media object creation and social publishing server computer programmed to:
a. provide to a user computing device, via a network, computer instructions that enable an operator of the user computing device to:
i. select an object format from a plurality of object formats available from a database at the server computer,
ii. select at least one content component from a plurality of content components available from the database at the server computer for integration into the multi-media object,
iii. send to the server computer multi-media object creation instructions in order to create the multi-media object in accordance with the selected object format and the selected content components, and
iv. designate at least one recipient of the multi-media object;
b. receive the from the user computing device the multi-media object creation instructions;
c. receive from the user computing device an identification of at least one designated recipient of the multi-media object; and
d. distribute via a social publishing network the multi-media object to the at least one designated recipient.

20. The server computer of claim 19 wherein the plurality of available object formats comprises a fixed dimension object and a variable dimension object.

21. The server computer of claim 19 wherein the plurality of available content components comprise a background file, an image file, a text file, a video file, an audio file, a drawing file, and an embeddable web address.

22. The server computer of claim 19 wherein a plurality of recipients are designated from a listing of available recipients.

23. The server computer of claim 19 further programmed to:
d. provide to a recipient computing device, via the network, computer instructions that enable the recipient computing device to:
i. display the multi-media object;
ii. enable selection of a content component from the multi-media object; and
iii. enable the selected content component to initiate a predefined action.

24. The server computer of claim 23 wherein the selected content component is an audio file, and wherein the predefined action initiated by the audio file is playback of audio content contained within the audio file.

25. The server computer of claim 23 wherein the selected content component is a video file, and wherein the predefined action initiated by the video file is playback of video content contained within the video file.

26. The server computer of claim 23 wherein the selected content component is an image file, and wherein the predefined action initiated by the image file is expansion of the image file to display at full resolution.

27. The server computer of claim 23 wherein the selected content component is an embeddable web address, and wherein the predefined action initiated by the embeddable web address is linking to content located at the web address.
